(19) United States
(12) Patent Application Publication
(10) Pub. No.: US 2015/0255836 A1
(43) Pub. Date: Sep. 10, 2015

(54) HEAT PIPE ASSEMBLY HAVING HEATING/COOLING FUNCTIONS, BATTERY MODULE FOR ECO-FRIENDLY VEHICLE USING THE SAME AND METHOD FOR OPERATING BATTERY MODULE

(71) Applicant: HYUNDAI MOBIS CO., LTD., Seoul (KR)

(72) Inventor: Yong-Jung Kim, Yongin-si (KR)

(21) Appl. No.: 14/637,214

(22) Filed: Mar. 3, 2015

(30) Foreign Application Priority Data
Mar. 7, 2014 (KR) 10-2014-0027214

(51) Int. Cl. H01M 10/613; H01M 2/26

(52) U.S. Cl. CPC H01M 10/613; H01M 10/615; H01M 10/623; H01M 10/6555; H01M 10/6561; H01M 10/6567; H01M 10/63; H01M 10/633; H01M 2/26

(57) ABSTRACT

A heat pipe assembly having heating/cooling functions may include a heat pipe, a first heat transfer plate having one side surface which is in contact with the heat pipe and the other side surface which is bordered to a battery cell installed in a battery module of an eco-friendly vehicle, and a second heat transfer plate having one side surface which is in contact with the heat pipe and the other side surface which is bordered to another battery cell adjacent to the battery cell, wherein the first heat transfer plate and the second heat transfer plate are coupled to each other, and the heat pipe is received between the first heat transfer plate and the second heat transfer plate.

### CROSS-REFERENCE TO RELATED APPLICATIONS

This application claims priority to Korean Patent Application No. 10-2014-0027214 filed on Mar. 7 2014, which is incorporated herein by reference in its entirety.

### BACKGROUND

1. Field

The present disclosure relates to a battery module mounted to an eco-friendly vehicle, and particularly, to a heat pipe assembly in which a heat pipe having heating/cooling functions is inserted and installed between battery cells constituting a battery module to enable the temperature of the battery module to be maintained at a suitable level, a battery module for an eco-friendly vehicle utilizing the heat pipe and a method for operating the battery module.

2. Description of Related Art

In an eco-friendly vehicle such as a hybrid vehicle or an electric vehicle, a battery module is provided for supplying electric power to a motor mounted to the vehicle.

In the battery module, a plurality of battery cells are stacked and electrically connected to each other.

Meanwhile, the temperature of the battery module should be maintained at a suitable level to enable the battery module to perform sufficiently.

In a battery module for an eco-friendly vehicle, there is no means or way to heat or cool the battery module, and in a case where the temperature of the battery module is low or high, the battery module does not perform sufficiently.

A heater, such as a PTC (positive temperature coefficient) heater, which is heated at the time of applying electric power, is provided between the battery cells constituting the battery module. The heater which is heated by electric power of the battery module to raise the temperature of the battery module has been proposed.

As another method, cooling water may be circulated in the battery module to cool the heated battery module.

In the typical battery module, however, an additional device should be provided for heating or cooling the battery module. A large space in the vehicle is occupied by the above device and this device causes an increase of vehicle weight. Therefore, the device for heating or cooling the battery module acts as a factor causing a decline of efficiency.

In addition, in a case where the above heater is provided, the heater should be connected to the battery cell or the battery module. Therefore, a plurality of connectors which should be connected to the battery module when the battery module is assembled are required.

Also, since the heater tends not to be brought in close contact with the battery cell, heat generated in the heater is not sufficiently transferred to the battery cell. Therefore, a difference between the temperatures of the battery cells may be generated.

Furthermore, in a structure in which cooling water is circulated for cooling the battery module, since it is difficult to circulate cooling water in the battery module including various kinds of electronic components, the battery module could not be rapidly cooled when the battery module is heated.

### SUMMARY

An aspect of the present invention is to provide a heat pipe assembly having heating/cooling functions and utilizing a heat pipe provided between battery cells constituting a battery module mounted in an eco-friendly vehicle to enable the battery cells to be heated or cooled, the battery module for an eco-friendly vehicle utilizing the heat pipe assembly, and a method for operating the battery module.

A heat pipe assembly having heating/cooling functions according to embodiments of the present invention includes a heat pipe; a first heat transfer plate having one side surface which is in contact with the heat pipe and the other side surface which is bordered to a battery cell installed in a battery module of an eco-friendly vehicle; and a second heat transfer plate having one side surface which is in contact with the heat pipe and the other side surface which is bordered to another battery cell adjacent to the battery cell. Here, the first heat transfer plate and the second heat transfer plate are coupled to each other, and the heat pipe is received between the first heat transfer plate and the second heat transfer plate.

In a battery module for an eco-friendly vehicle utilizing the heat pipe assembly having the heating/cooling functions, a plurality of battery cells are disposed and the above heat pipe assembly is provided between the adjacent battery cells.

A method for operating a battery module for an eco-friendly vehicle utilizing a heat pipe assembly having heating/cooling functions according to one aspect of the present invention includes a battery cell temperature measuring step for measuring a temperature of a battery cell provided in the battery module of the eco-friendly vehicle; a battery cell heating judging step for judging whether the temperature of the battery cell is lower than a battery cell heating temperature at which the battery cell should be heated; a battery cell heating step for supplying heating fluid to the heat pipe exposed out of the battery cell if the temperature of the battery cell is lower than the battery cell heating temperature; a battery cell cooling judging step for judging whether, if the temperature of the battery cell is higher than the battery cell heating temperature, the temperature of the battery cell is higher than a battery cell cooling temperature at which the battery cell should be cooled; and a battery cell cooling step for supplying cooling fluid to the heat pipe exposed out of the battery cell if the temperature of the battery cell is higher than the battery cell cooling temperature.

### BRIEF DESCRIPTION OF THE DRAWINGS

FIG. 1 is a perspective view showing a state in which a battery module is coupled to a heat pipe assembly having heating/cooling functions according to an embodiment of the present invention;

FIG. 2 is a perspective view showing a state in which a battery module and a heat pipe assembly shown in FIG. 1 are detached from each other;

FIG. 3 is an exploded perspective view of a heat pipe assembly having heating/cooling functions according to an embodiment of the present invention;

FIG. 4 is a perspective view of a heat pipe of a heat pipe assembly having heating/cooling functions according to an embodiment of the present invention;

FIG. 5 is a perspective view showing a state in which a heat transfer material is applied on a heat pipe of a heat pipe assembly having heating/cooling functions according to an embodiment of the present invention;

FIG. 6 is a partially enlarged perspective view showing a state in which an electrode contact part is formed on a heat transfer plate of a heat pipe assembly having heating/cooling functions according to an embodiment of the present invention;

FIG. 7 is a partial enlarged perspective view showing a state in which a coupling part and a coupling hole are formed on a heat transfer plate of a heat pipe assembly having heating/cooling functions according to an embodiment of the present invention;

FIG. 8 is a perspective view of a battery module for an eco-friendly vehicle, which utilizes a heat pipe assembly having heating/cooling functions according to an embodiment of the present invention;

FIG. 9 is an exploded perspective view of a battery module for an eco-friendly vehicle, which utilizes a heat pipe assembly having heating/cooling functions according to an embodiment of the present invention;

FIG. 10 and FIG. 11 are perspective views showing a state in which a battery heat pipe assembly and a battery cell are inserted into a lower housing in a battery module for an eco-friendly vehicle utilizing a heat pipe assembly having heating/cooling functions according to an embodiment of the present invention;

FIG. 12 is a plane view showing an essential part in a state in which a battery heat pipe assembly and a battery module are mounted to a lower housing in a battery module for an eco-friendly vehicle utilizing a heat pipe assembly having heating/cooling functions according to an embodiment of the present invention;

FIG. 13 is view showing a front surface and a rear surface of a battery module for an eco-friendly vehicle utilizing a heat pipe assembly having heating/cooling functions according to an embodiment of the present invention, and this drawing shows a battery module to which an upper housing and a cell electrode protection pad are not coupled; and

FIG. 14 is a flow chart for showing an operation method of a battery module for an eco-friendly vehicle utilizing a heat pipe assembly having heating/cooling functions according to another embodiment of the present invention.

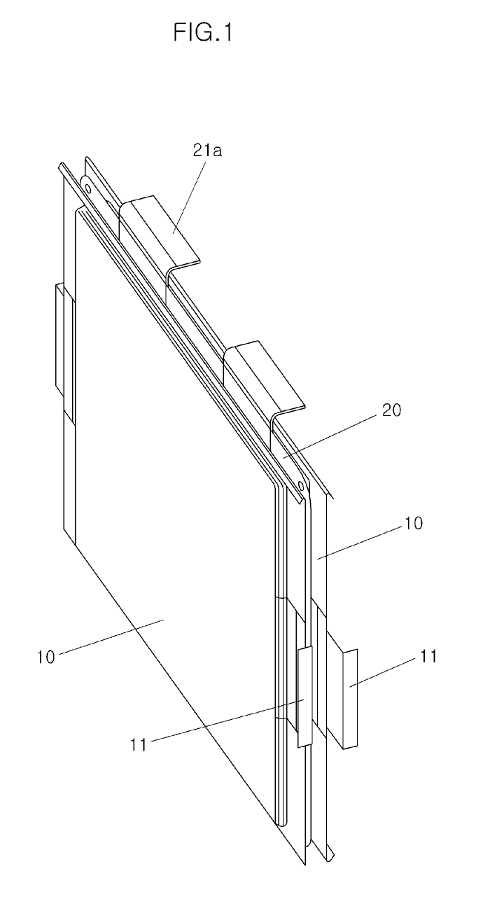

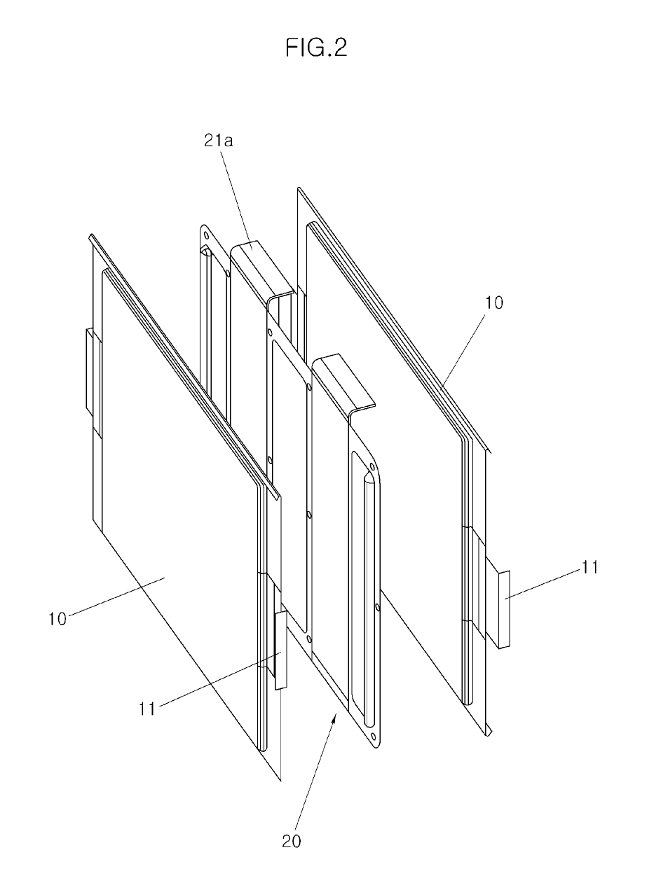

### DESCRIPTION OF EMBODIMENTS

Hereinafter, a heat pipe assembly having heating/cooling functions, a battery module for an eco-friendly vehicle utilizing the heat pipe assembly and an operation method of the battery module according to an embodiment of the present invention will be described in detail with reference to the accompanying drawings. The present invention may, however, be embodied in different forms and should not be construed as limited to the embodiments set forth herein. Rather, these embodiments are provided so that this disclosure will be thorough and complete and will fully convey the scope of the present invention to those skilled in the art. Throughout the disclosure, like reference numerals refer to like parts throughout the various figures and embodiments of the present invention.

A heat pipe assembly having heating/cooling functions includes a heat pipe 21; a first heat transfer plate 22 having one side surface which is in contact with the heat pipe 21 and the other side surface which is bordered to a battery cell 10 installed in a battery module 1 of an eco-friendly vehicle; and a second heat transfer plate 23 having one side surface which is in contact with the heat pipe 21 and the other side surface which is bordered to another battery cell 10 adjacent to the above battery cell 10. Here, the first heat transfer plate 22 and the second heat transfer plate 23 are coupled to each other, and the heat pipe 21 is received between the first heat transfer plate and the second heat transfer plate.

The heat pipe 21 is a pipe-shaped and depressurized member containing liquid therein for transferring heat between two points having different temperatures. In the heat pipe, once one end of the heat pipe is heated, liquid is evaporated to form steam. Steam is moved to the other end and radiates heat at the other end, and is thus condensed. Liquid is returned to one end by the capillary phenomenon.

By utilizing the above heat pipe 21, an inside of the battery module 1 of the eco-friendly vehicle is heat-exchanged with the outside.

One end of the heat pipe 21 is exposed out of the battery module 1 and the remainder is located in the battery module 1 so that the heat pipe 21 is heat-exchanged with the battery cell 10 constituting the battery module 1.

In other words, the heat pipe 21 includes a first heat exchanging part 21a exposed out of the battery module 1 and a second heat exchanging part 21b inserted into the battery module 1.

The heat pipe is configured such that the first heat exchanging part 21a is bent with respect to the second heat exchanging part 21b. Due to this configuration, when another heat pipe assembly 20 is mounted to the battery module 1, a contact surface is formed between the first heat exchanging part of the heat pipe and a first heat exchanging part 21a formed on a heat pipe 21 of another heat pipe assembly 20 so that a heat-exchange between the inside of the battery module 1 and the outside is facilitated.

Liquid encapsulated in the heat pipe 21 is circulated in the first heat exchanging part 21a and the second heat exchanging part 21b to enable the battery cell 10 to be heat-exchanged with the outside of the battery cell 10. More concretely, if the temperature of the battery cell 10 on which the second heat exchanging part 21 is placed is extremely low or high, the efficiency of the battery module 1 is declined. Therefore, by increasing or raising the temperature of the first heat exchanging part 21a placed at the outside of the battery module 1, the first heat exchanging part 21a and the second heat exchanging part 21b of the heat pipe 21 are heat-exchanged with each other. Ultimately, it is possible to maintain the temperature of the battery cell 10 at a suitable level.

A plurality of heat pipes 21 are disposed in the heat pipe assembly 20 at certain intervals.

The first heat transfer plate 22 and the second heat transfer plate 23 are in contact with both side surfaces of the heat pipe 21, respectively, and the first heat transfer plate 22 and the second heat transfer plate 23 are coupled to each other.

The first heat transfer plate 22 is in close contact with one side surface of the heat pipe 21. Here, the heat pipes 21 disposed at intervals can be in direct contact with the battery cell 10. However, if the heat pipe 21 is in direct contact with the battery cell 10 as above, since a heat exchange is generated on only a contact portion, a temperance difference is generated in the battery cell 10 and it is difficult to adjust the temperature of the part which is not in contact with the heat pipe 21. Therefore, by disposing the first heat transfer plate formed of metal material between the heat pipe 21 and the battery cell 10, the heat change between the heat pipe 21 and the entire surface area of the battery cell 10 can be obtained.

The second heat transfer plate 23 is in contact with the other surface of the heat pipe 21 and is coupled to the first heat transfer plate 22. Also, the second heat transfer plate 23 makes an entire surface area of the battery cell 10 at which the second heat transfer plate 23 is disposed to have a uniform temperature distribution.

Since, in a state where the heat pipe 21 is disposed between the first heat transfer plate 22 and the second heat transfer plate 23, the second heat transfer plate 23 is coupled to the first heat transfer plate 22, the heat exchange between the heat pipe 21 and each of the battery cells 10 disposed at both sides of the heat pipes 21 is generated.

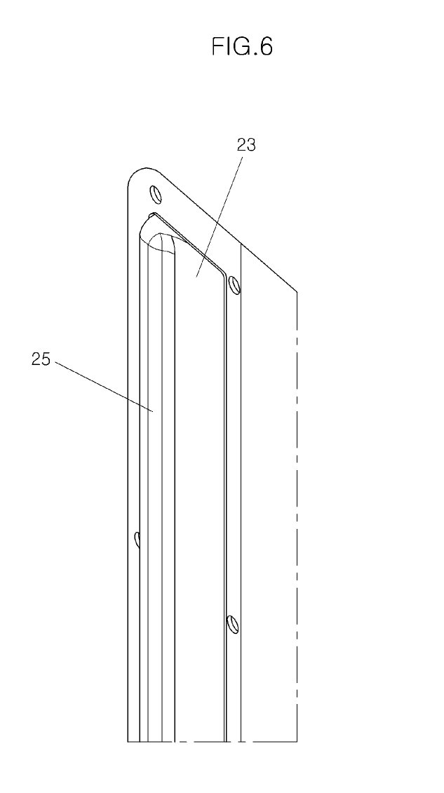

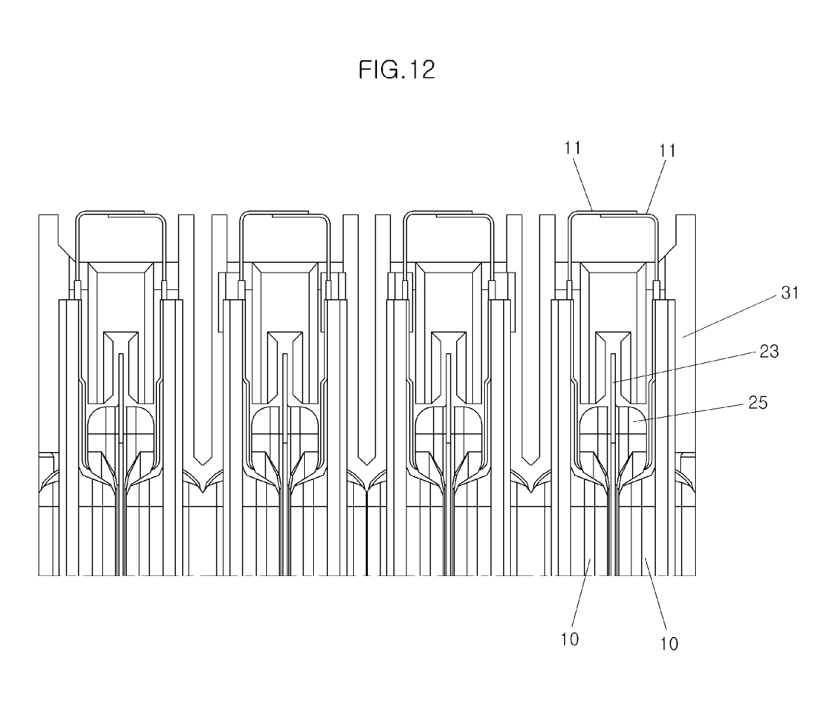

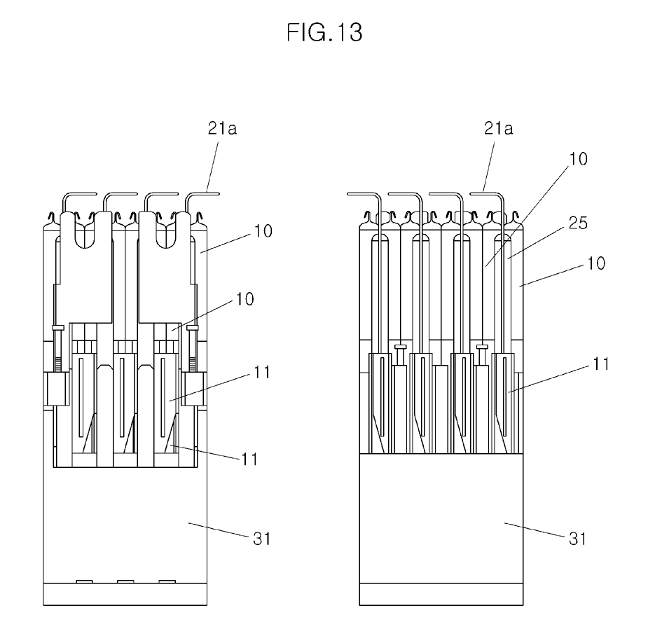

Electrode contact parts 25, which convexly protrude from the first heat transfer plate 22 and the second heat transfer plate 23, are formed on circumference regions of the first heat transfer plate 22 and the second heat transfer plate 23, that is, regions which are in contact with an electrode 11 of the battery cell 10, respectively, as shown in FIG. 6. As compared with other regions, the first heat transfer plate 22 is in more close contact with the battery cell 10 through the electrode contact part 25 (see FIG. 12) so that it is possible to intensively heat or cool the electrode 11. Forming processes are performed for the first heat transfer plate 22 and the second heat transfer plate 23, respectively, to form the electrode contact parts 25. In addition, the electrode contact part 25 is formed parallel to the heat pipe 21.

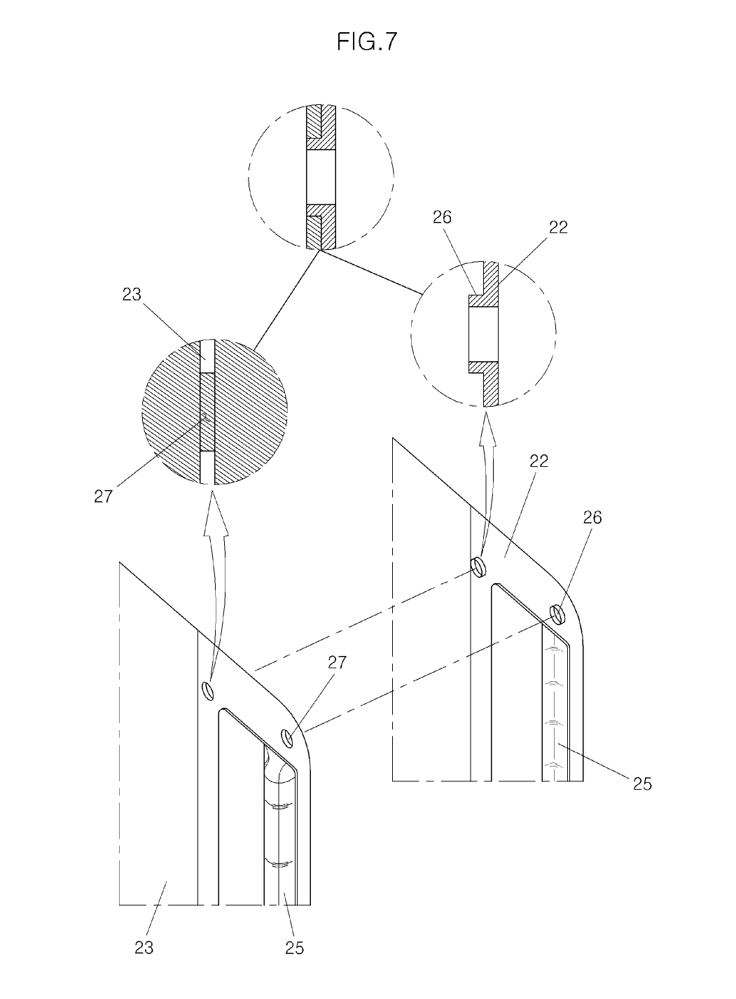

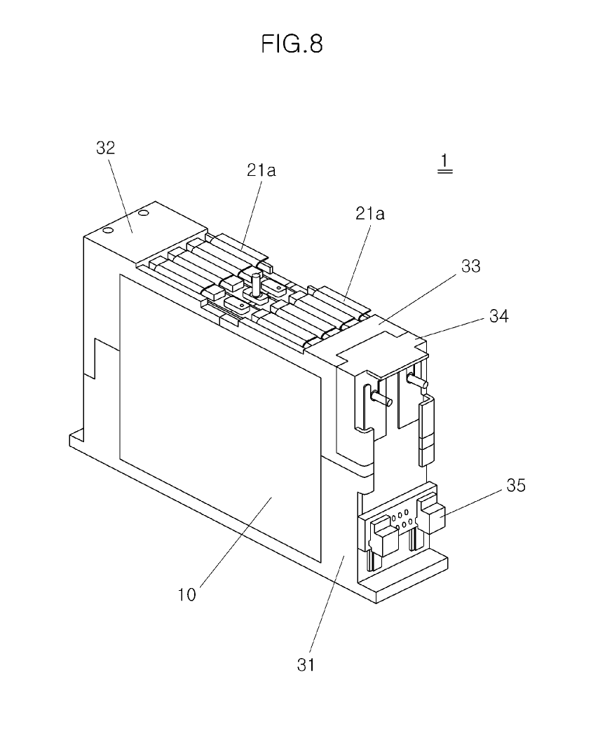

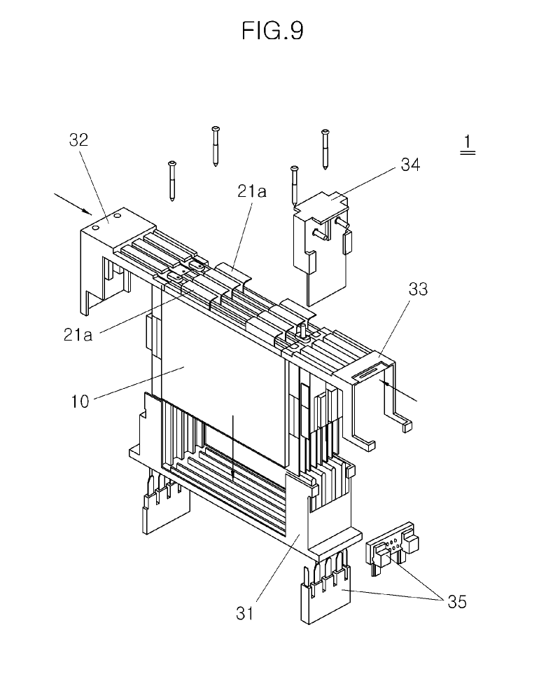

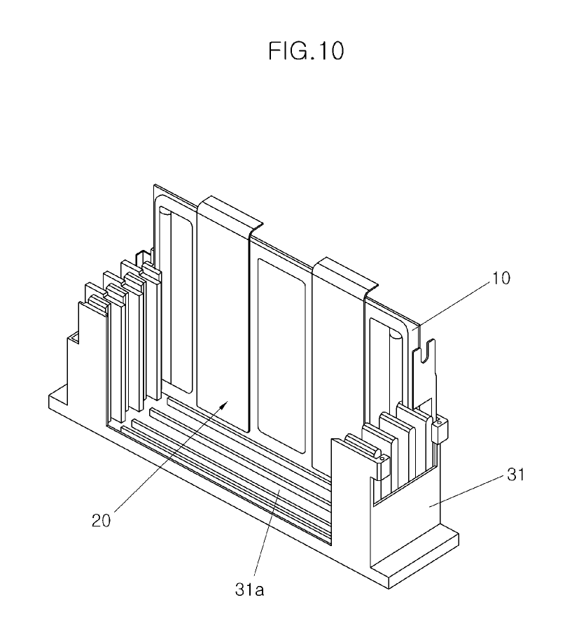

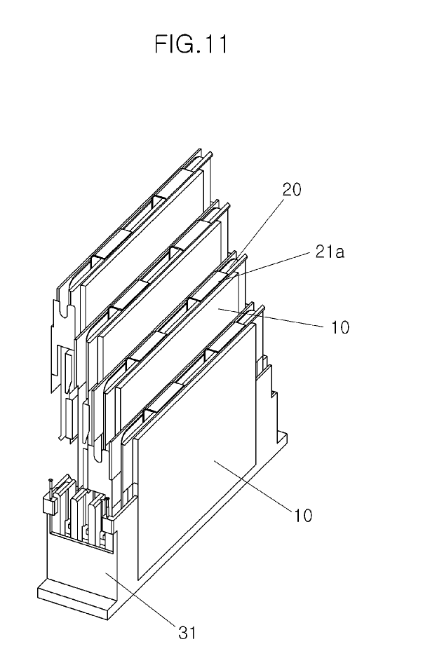

The first heat transfer plate 22 and the second heat transfer plate 23 have configurations which can be coupled to each other. In order to couple the first heat transfer plate 22 and the second heat transfer plate 23 to each other, one heat transfer plate 22 or 23 of the first heat transfer plate 22 and the second heat transfer plate 23 has a coupling part 26 formed thereon and protruded toward the other transfer plate 23 or 22, and the other heat transfer plate 23 has a coupling hole 27 formed thereon for receiving the coupling part 26. As shown in FIG. 7, for example, the coupling part 26 is formed on the first heat transfer plate 22, and the coupling hole 27 in which the coupling part 26 is inserted is formed on the second heat transfer plate 23. Due to the above configuration, by inserting the coupling part 26 in the coupling hole 27, it is possible to couple the first heat transfer plate 22 and the second heat transfer plate 23 to each other. Here, as the method for forming the coupling part 26 on the first heat transfer plate 22 and coupling hole 27 on the second heat transfer plate 23, a caulking method in which a caulking tool is applied from the first heat transfer plate 22 to the second heat transfer plate 23 in a state where the first heat transfer plate 22 and the second heat transfer plate 23 overlap each other may be employed to couple the first heat transfer plate 22 and the second heat transfer plate 23 to each other.

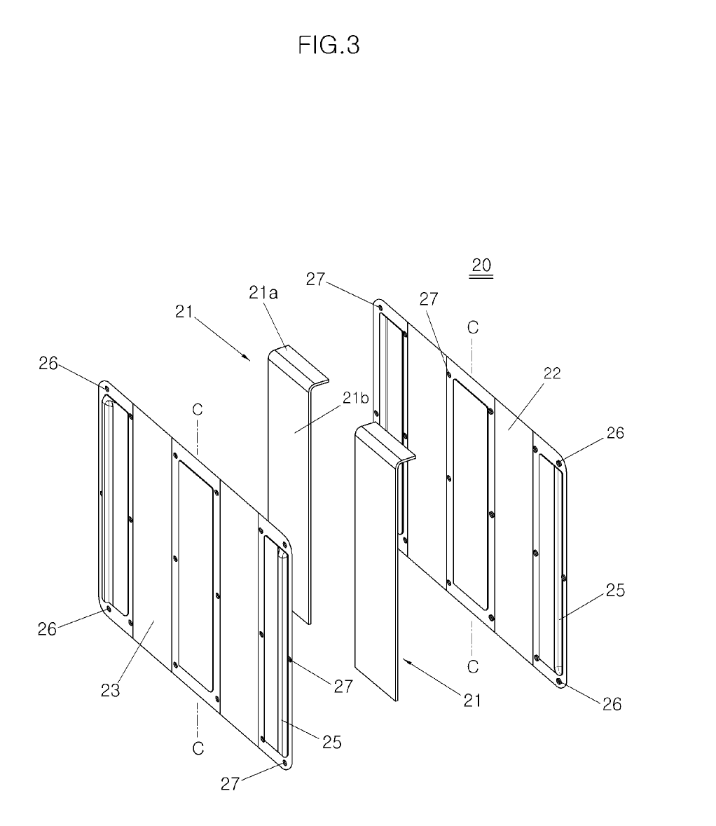

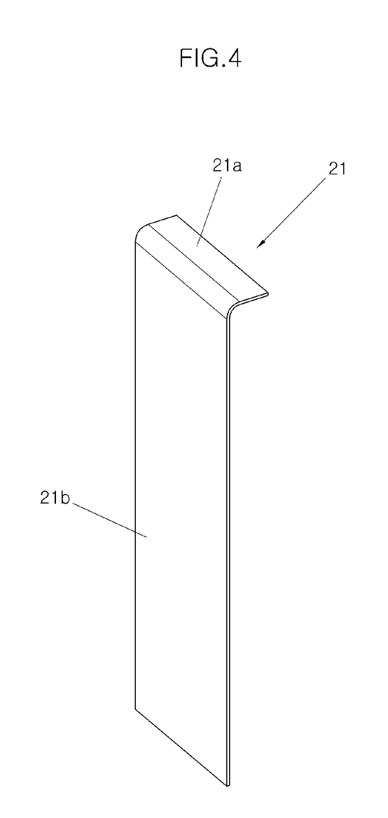

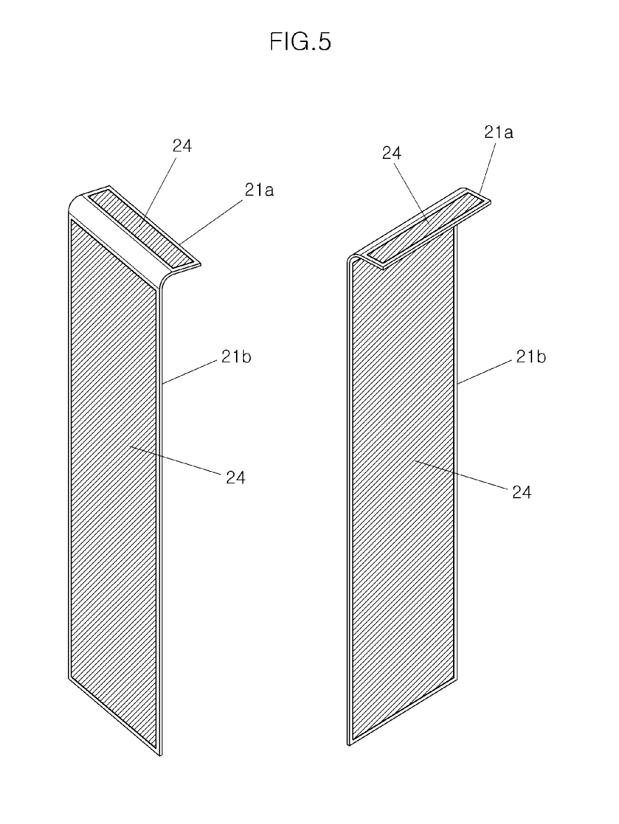

In addition, the first heat transfer plate 22 and the second heat transfer plate 23 may be formed such that the coupling hole 27 and the coupling part 36 are formed on a right half portion and a left half portion, respectively. In the first heat transfer plate 22 and the second heat transfer plate 23 as shown in FIG. 3, for example, the coupling part 26 is formed on the left half portion with respect to the line C-C and the coupling hole 27 is formed on the right half portion. In these configurations, after turning any one of the heat transfer plate 22 and the second heat transfer plate 23 over, two transfer plates can be coupled to each other.

As described above, if the coupling hole 27 and the coupling part 26 are formed on the left portion and the right portion of each of the first heat transfer plate 22 and the second heat transfer plate 23, respectively, the first heat transfer plate 22 and the second heat transfer plate 23 may have the same shape. If any one of the first heat transfer plate 22 and the second heat transfer plate 23 having the same shape is turned over, the coupling part 26 of the first heat transfer plate 22 or the second heat transfer plate 23 corresponds to the coupling hole 27 of the second heat transfer plate 23 or the first heat transfer plate 22 so that the first heat transfer plate 22 can be coupled to the second heat transfer plate 23. In addition, since the first heat transfer plate 22 and the second heat transfer plate 23 have the same shape, just one mold is required for manufacturing the first heat transfer plate 22 and the second heat transfer plate 23.

Also, thermal interface material (TIM) is applied to a surface of the heat pipe 21. For example, by applying a thermal interface material 24 on the second heat exchanging part 21b which is in contact with the first heat transfer plate 22 and the second heat transfer plate 23, a gap between the heat pipe 21 and each of the first heat transfer plate 22 and the second heat transfer plate 23 is removed to expedite the heat exchange.

By disposing the heat pipe assembly 20 having the configuration as above in the battery module 1, the inside of the battery module 1 is heat-exchanged with the outside so that it is possible to maintain the inside of the battery module 1 at a suitable temperature. In the heat pipe assembly 20, in other words, since the first heat exchanging part 21a of the heat pipe 21 is exposed to the outside and the second heat exchanging part 21b is placed in the inside of the heat pipe assembly 20, if the temperature of the battery cell 10 is extremely high, the first heat exchanging part 21a is cooled to the low temperature which is lower that the temperature of the battery cell 10 so that the second heat exchanging part 21b can absorb heat generated from the high temperature battery cell 10 and the first heat exchanging part 21a can radiate heat to reduce the temperature of the battery cell 10. On the contrary, if the temperature of the battery cell 10 is extremely low, the first heat exchanging part 21a is raised to the high temperature which is higher than the temperature of the battery cell 10 so that heat of the first heat exchanging part 21a is absorbed and radiated through the second heat exchanging part 21b to raise the temperature of the battery cell 10.

The heat pipe assembly having the heating/cooling functions according to an embodiment of the present invention is provided in the battery module mounted to the eco-friendly vehicle.

A plurality of battery cells 10 are arranged and are electrically connected to each other in the battery module 1. By arranging the heat pipe assembly 20 between the battery cells 10, the battery cell 10 is heated or cooled to maintain the temperature of the battery cells 10 at a suitable level.

In the battery module for the eco-friendly vehicle utilizing the heat pipe assembly having the heating/cooling functions according to an embodiment of the present invention, a plurality of battery cells 10 and the heat pipe assembly 20 are disposed among a lower housing 31 and an upper housing 32 and 33. The battery cells 10 and the heat pipe assemblies 20 may be alternatively disposed, and one heat pipe assembly 20 and two battery cells 10 disposed on both side surfaces of the heat pipe assembly may be constituted as one set and disposed in the battery module.

The lower housing 31 has a slot 31a formed thereon for preventing the battery cell 10 and the heat pipe assembly 20 installed therein from being deviated due to a vibration or an impact. Since a plurality of slits 31a are formed in the longitudinal direction and disposed parallel to each other, the battery cells 10 and the heat pipe assembly 20 are securely received in the slots 31a. The battery cells 10 and the heat pipe assembly 20 are moved downward from the upper housing 31 and then inserted in the slots 31a.

The upper housing 32, 33 covers upper portions of the battery cell 10 and the heat pipe assembly 20 installed in the lower housing 31. In particular, the upper housing 32, 33 includes a first upper housing 32 and a second upper housing 33 to enable the first heat exchanging part 21a to be exposed in a state where the heat pipe assembly 20 is installed. The first upper housing 32 and the second upper housing 33 pass through a portion of the heat pipe 21 of the heat pipe assembly 20, which is exposed to the outside, that is, pass below a lower surface of the first heat exchanging part 21a of the heat pipe 21 and are then coupled to each other. As described above, since the first upper housing 32 and the second upper housing 33 pass below the lower surface of the first heat exchanging part 21a of the heat pipe 21 and are coupled to each other, in a state where the first upper housing 32 and the second upper housing 33 are coupled to each other, the first heat exchanging part 21a is exposed to the outside so that high temperature air or cooling water or low temperature air or cooling water can be supplied to the first heat exchanging part 21a to perform a heat exchange between the inside of the battery cell 10 and the outside.

Meanwhile, the battery cell 10 inserted in the lower housing 31 is connected to another adjacent battery cell 10. In a state where the battery cells are disposed and inserted in the lower housing 31, the electrodes 11 of the adjacent battery cells 10 are welded to each other to connect the adjacent battery cells to each other. In particular, when the battery cells 10 are welded to each other by, for example, a laser welding process.

Except for the electrodes, side surfaces of the battery cells 10 packaged with the lower housing 31 and the upper housing 32, 33 are coupled to a cell electrode protection pad 34 to prevent the side surfaces of the battery cells 10 from being exposed to the outside and to protect the side surfaces of the battery cells 10.

Reference numeral 35 indicates a voltage sensing unit connected to the electrode 11 of the battery cell 10 for measuring a voltage of the battery module 1.

A method for operating the battery module for an eco-friendly vehicle using the heat pipe assembly having the heating/cooling functions according to another embodiment of the present invention is illustrated as below.

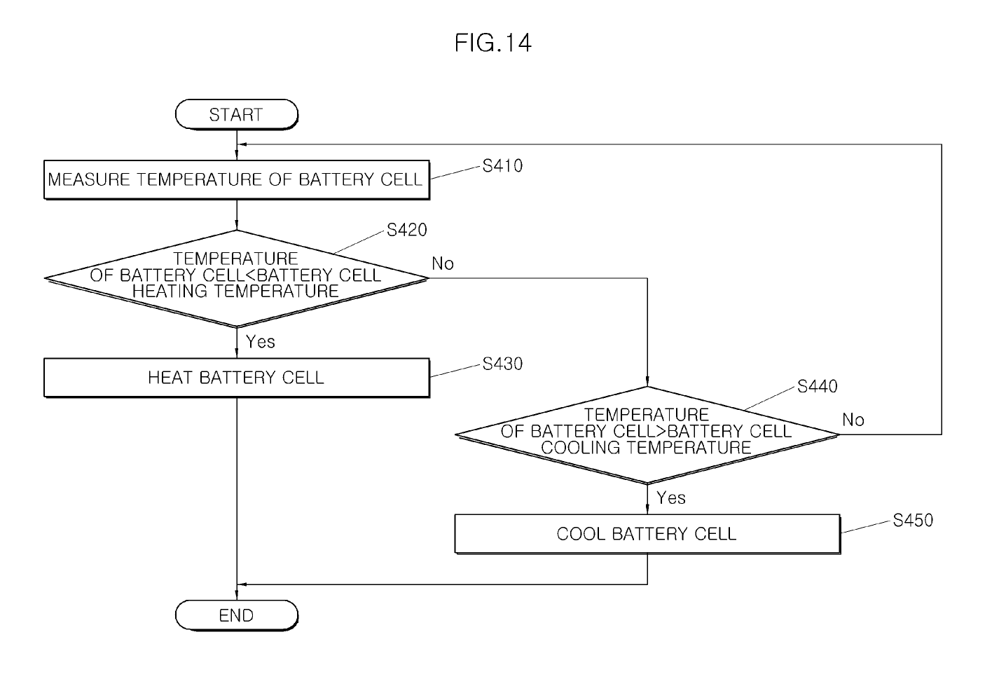

As shown in FIG. 14, a method for operating the battery module for the eco-friendly vehicle using the heat pipe having the heating/cooling functions according to the embodiment includes: a battery cell temperature measuring step S410 for measuring the temperature of the battery cell 10 provided in the battery module 1 of the eco-friendly vehicle; a battery cell heating judging step S420 for judging whether the temperature of the battery cell 10 is lower than a battery cell heating temperature at which the battery cell 10 should be heated; a battery cell heating step S430 for supplying heating fluid to the heat pipe 21 exposed out of the battery cell 10 if the temperature of the battery cell 10 is lower than the battery cell heating temperature; a battery cell cooling judging step S440 for judging whether, if the temperature of the battery cell 10 is higher than the battery cell heating temperature, the temperature of the battery cell 10 is higher than a battery cell cooling temperature at which the battery cell 10 should be cooled; and a battery cell cooling step S450 for supplying cooling fluid to the heat pipe 21 exposed out of the battery cell 10 if the temperature of the battery cell 10 is higher than the battery cell cooling temperature.

In the battery cell temperature measuring step S410, the current temperature of the battery 10 is measured.

The battery cell heating judging step S420 is the process for judging whether the temperature of the battery cell 10, which is measured in the battery cell temperature measuring step S410, is lower than the battery cell heating temperature which is set in advance as the temperature at which the battery cell 10 should be heated. If the temperature of the battery cell 10 is lower than the battery cell heating temperature, the temperature of the battery cell 10 should be raised.

In the battery cell heating step S430, in a case where the temperature of the battery cell 10 is lower than the battery cell heating temperature, in order to raise the temperature of the battery cell 10, the battery cell 10 is heat-exchanged with the outside of the battery module 1 by means of the heat pipe assembly 20. In the battery cell heating step S430, heating fluid, that is, high temperature air or heated cooling water having the temperature which is higher than the temperature of the battery cell 10, flows to the first heat exchanging part 21a of the heat pipe 21. Once high temperature air or heated cooling water is introduced to the first heat exchanging part 21a, the first heat exchanging part 21a of the heat pipe 21 becomes a high temperature part and the second heat exchanging part 21b located in the battery cell 10 becomes a low temperature part. Therefore, while circulating in the heat pipe 21, the fluid absorbs heat in the first heat exchanging part 21a and radiates heat in the second heat exchanging part 21b to raise the temperature of the battery cell 10. As a result, the temperature of the battery cell 10 is maintained at a suitable level.

In the battery cell heating judging step S420, if the temperature of the battery cell 10 is higher than the battery cell heating temperature, the battery cell cooling judging step S440 is performed. In the battery cell cooling judging step S440, the temperature of the battery cell 10 is compared with the battery cell cooling temperature which is set in advance as a reference temperature at which the battery cell 10 should be cooled, and it is judged whether the temperature of the battery cell 10 is higher than the battery cell cooling temperature.

If the temperature of the battery cell 10 is higher than the battery cell cooling temperature in the battery cell cooling judging step S440, the battery cell 10 is cooled by means of the heat pipe assembly 20 in the battery cell cooling step S450. In the battery cell cooling step S450, cooling fluid, that is, low temperature air or cooling water having the temperature which is lower than the temperature of the battery cell 10, flows to the first heat exchanging part 21a of the heat pipe 21. While flowing to the first heat exchanging part 21a, low temperature air or cooling water absorbs heat in the second heat exchanging part 21b of the heat pipe 21 and radiates heat in the first heat exchanging part 21a to cool the battery cell 10.

If the temperature of the battery cell 10 is lower than the battery cell cooling temperature in the battery cell cooling judging step S440, the procedure is returned to the battery cell temperature measuring step S410.

Here, after the battery cell temperature measuring step S410, the battery cell cooling judging step S440 and the battery cell cooling step S450 may be performed. Also, if the temperature of the battery cell 10 is lower than the battery cell cooling temperature in the battery cell cooling judging step S440, the battery cell heating judging step S420 and the battery cell heating step S430 may be performed.

Meanwhile, the battery cell heating temperature is set to be lower than the battery cell cooling temperature to maintain the temperature of the battery cell 10 between the battery cell heating temperature and the battery cell cooling temperature.

The battery management system controls the above steps.

According to the heat pipe assembly having the heating/cooling functions and the above structure, the battery module for the eco-friendly vehicle utilizing the above heat pipe assembly and the method for operating the above battery module of an embodiment of the present invention, since the heat pipe assembly including the heat pipe which can heat or cool the battery cell is provided between the battery cells constituting the battery module, the battery cell is heated or cooled by means of the heat pipe assembly so that it is possible to maintain the temperature of the battery module at a suitable level and efficiency of the battery module is thus enhanced.

As described above, since the heat pipe assembly, which is the means for maintaining the temperature of the battery module at a suitable level, performs all the functions of heating and cooling the battery cell, the weight of the vehicle can be reduced. Also, the device for maintaining the temperature of the battery module at a suitable level becomes smaller so that a degree of freedom in the vehicle design is enhanced.

In addition, since the heat pipe assembly is in close contact with the battery cell and heats or cools the battery cell, air or cooling water does not flow around the battery module. As a result, an undesirable phenomenon such as a short is not generated in the battery module so that the stability of the battery module is enhanced.

While the present invention has been described with respect to the specific embodiments, it will be apparent to those skilled in the art that various changes and modifications may be made without departing from the spirit and scope of the invention as defined in the following claims.

What is claimed is:

1. A heat transfer device comprising;
a heat pipe;
a first heat transfer plate comprising a first surface contacting the heat pipe and a second surface facing away from the first surface and configured to contact a battery cell of a vehicle; and
a second heat transfer plate comprising a third surface opposing the first surface and contacting the heat pipe and a fourth surface facing away from the third surface and configured to contact another battery cell immediately neighboring to the battery cell such that a heat pipe, the first heat transfer plate and the second heat transfer plate are located between the battery cell and the other battery cell,
wherein the first heat transfer plate and the second heat transfer plate are coupled to each other such that the heat pipe is located between the first heat transfer plate and the second heat transfer plate.

2. The device of claim 1, wherein the heat pipe comprises a portion adjacent to one end exposed out of the first and second heat transfer plates and configured to act as a first heat exchanging part which is heat-exchanged with an outside of the battery module and another portion received between the first heat transfer plate and the second heat transfer plate configured to act as a second heat exchanging part which is heat-exchanged with the battery cell.

3. The device of claim 2, wherein the first heat exchanging part is bent with respect to the second heat exchanging part.

4. The device of claim 1, wherein a surface of the heat pipe is coated with thermal interface material (TIM).

5. The device of claim 1, wherein one of the first heat transfer plate and the second heat transfer plate has a coupling part formed thereon and protruding to the other one, and the other has a coupling hole formed thereon for receiving the coupling part, whereby the first heat transfer plate and the second heat transfer plate are coupled to each other when the coupling part is inserted in the coupling hole.

6. The device of claim 5, wherein the coupling part is formed on one of a left portion and a right portion of each of the first heat transfer plate and the second heat transfer plate, and the coupling hole is formed on the other one of the left portion and the right portion.

7. The device of claim 6, wherein the first heat transfer plate and the second heat transfer plate have the same shape.

8. The device of claim 1, wherein at least one of the first heat transfer plate and the second heat transfer plate has an electrode contact part formed on a portion thereof adjacent to an electrode of the battery cell and protruded therefrom.

9. A battery module mounted in a vehicle, the battery module comprising:
a plurality of battery cells; and
the heat transfer device of claim 1 and disposed between two immediately neighboring battery cells among the plurality of battery cells.

10. The battery module of claim 9, wherein the battery module comprises a lower housing having a plurality of slots formed thereon and disposed parallel to each other, and the two immediately neighboring battery cells and the heat pipe assembly are inserted in one of the slots.

11. The battery module of claim 10, further comprising an upper housing covering upper ends of the battery cells, and one end of the heat pipe is exposed out of the upper housing.

12. The battery module of claim 11, wherein the upper housing comprises a first upper housing and a second upper housing separated from the first upper housing, the first upper housing and the second upper housing are slid in the direction perpendicular to the direction in which the battery cells are disposed and are then coupled to each other.

13. The battery module of claim 12, wherein the first upper housing and the second upper housing pass below a portion of the heat pipe, which is exposed to an outside, and are connected to each other.

14. The battery module of claim 11, wherein an electrode of the battery cell is laser-welded to an electrode of the adjacent battery cell, the welded electrodes having different polarities, so that the adjacent battery cells are electrically connected to each other.

15. The battery module of claim 12, wherein the upper housing has a cell electrode protection pad coupled to one side thereof for inhibiting a side surface of the battery cell from being exposed to an outside.

16. A method of operating the battery module of claim 9 in a vehicle, the method comprising;
a battery cell temperature measuring step for measuring a temperature of a battery cell provided in the battery module of the vehicle;
a battery cell heating judging step for judging whether the temperature of the battery cell is lower than a battery cell heating temperature at which the battery cell should be heated;
a battery cell heating step for supplying heating fluid to the heat pipe exposed out of the battery cell if the temperature of the battery cell is lower than the battery cell heating temperature;
a battery cell cooling judging step for judging whether, if the temperature of the battery cell is higher than the battery cell heating temperature, the temperature of the battery cell is higher than a battery cell cooling temperature at which the battery cell should be cooled; and
a battery cell cooling step for supplying cooling fluid to the heat pipe exposed out of the battery cell if the temperature of the battery cell is higher than the battery cell cooling temperature.

17. The method of claim 16, wherein if the temperature of the battery cell is lower than the battery cell cooling temperature in the battery cell cooling judging step, the procedure is returned to the battery cell temperature measuring step.

18. The method of claim 16, wherein the battery cell heating temperature is set to be lower than the battery cell cooling temperature.

19. The method of claim 16, wherein the cooling fluid is cooling air or cooling water having the temperature which is lower than that of the battery cell and the heating fluid is heated air or heated cooling water having the temperature which is higher than that of the battery cell.

20. The method of claim 16, wherein after the battery cell temperature measuring step, the battery cell cooling judging step and the battery cell cooling step are performed, and if the temperature of the battery cell is lower than the battery cell cooling temperature in the battery cell cooling judging step, the battery cell heating judging step and the battery cell heating step are performed.
